(19) United States
(12) Patent Application Publication
(10) Pub. No.: US 2023/0284634 A1
(43) Pub. Date: Sep. 14, 2023

(54) COMPOSITION AND METHOD OF TREATING PLANT MATERIAL

(71) Applicant: MAXSTIM LIMITED, Farnham Surrey (GB)

(72) Inventor: John Richard SALVAGE, Farnham Surrey (GB)

(21) Appl. No.: 18/016,657

(22) PCT Filed: Jul. 16, 2021
(86) PCT No.: PCT/GB2021/051833

§ 371 Date: Jan. 17, 2023

(30) Foreign Application Priority Data
Jul. 17, 2020 (GB) 2011066.4

(51) Int. Cl. A01N 65/36; A01N 25/12; A01N 59/00; A01P 21/00

(52) U.S. Cl. CPC A01N 65/36; A01N 25/12; A01N 59/00; A01P 21/00

(57) ABSTRACT

A biostimulant composition is provided, the composition comprising Aegle marmelos leaf particulate or an extract from Aegle marmelos leaf, the extract having been obtained with a solvent.

### BACKGROUND OF THE INVENTION

The present disclosure relates to a composition, such as a composition that acts as a biostimulant.

The present invention concerns biostimulants. More particularly, but not exclusively, this invention concerns a plant treatment composition, optionally a biostimulant composition. The invention also concerns use of Aegle marmelos leaf particulate or an extract from Aegle marmelos leaf as a biostimulant. The invention also concerns a method of treating a plant or plant propagation material.

It is well-known to apply one or more biostimulants to plants or plant propagation material in order to stimulate growth. Many such biostimulants are synthetic (man-made) and therefore have to undergo extensive testing to determine their toxicity. The bael tree (Aegle marmelos) is indigenous to India and South East Asia. It is a deciduous shrub or small-medium-sized tree growing up to 13 m tall. The fruit can be eaten fresh or made into foodstuff and drinks. The leaves, bark, roots, fruits and seeds have been used in traditional medicine. Furthermore, it is known to use essential oils extracted from Aegle marmelos leaf as a biostimulants (see, for example, US2009/0318293).

The present invention seeks to mitigate the above-mentioned problem. Alternatively or additionally, the present invention seeks to provide an improved biostimulant composition.

### SUMMARY OF THE INVENTION

The present invention provides a plant treatment composition comprising Aegle marmelos leaf particulate and/or an extract from Aegle marmelos leaf, the extract having been obtained with a solvent.

The applicant has surprisingly discovered that both Aegle marmelos leaf particulate and an extract from Aegle marmelos leaf, the extract having been obtained with a solvent, and preferably a solvent comprising water (i.e. an aqueous solvent), produce a stimulant effect on plants and plant propagation material. Aegle marmelos leaf particulate has been found to be particularly effective, and leaf particulate is advantageous in that it is quick to prepare and uses no solvents. Also, the applicant has surprisingly found that, in certain embodiments, when the Aegle marmelos leaf particulate and/or the extract obtained with an aqueous solution is combined with other known biostimulants a synergistic effect may be created and may improve the performance of the other known biostimulants. The plant treatment composition is optionally a biostimulant plant treatment composition.

The applicant has also surprisingly found that when the Aegle marmelos leaf particulate and/or the extract obtained with an aqueous solution is combined with a substrate to support plant growth, the performance of the substrate may be enhanced.

Throughout the specification, Aegle marmelos is sometimes abbreviated as “A.m.”

The plant treatment composition is for the treatment of plants and plant propagation material and optionally is a biostimulant composition.

If the composition comprises an extract from Aegle marmelos leaf, the extract having been obtained with a solvent, then the composition optionally comprises the solvent. The solvent optionally comprises a polar solvent. The solvent optionally comprises an aqueous solvent i.e. a solvent comprising water.

For the avoidance of doubt, plant propagation material (sometimes referred to herein as “propagation material”) includes all plant material suitable for the propagation of plants, including but without limitation all generative parts of a plant, including seeds, roots, fruit, spores, storage organs (including, but not limited to, bulbs, corms, tubers and rhizomes) and cuttings.

For the avoidance of doubt, substrates include all materials used to provide support, nutrient, anchoring and any means to allow plants to grow.

For the avoidance of doubt, a biostimulant is a material that contains substances and/or micro-organisms whose function is to stimulate natural processes to enhance/benefit nutrient uptake, nutrient efficiency, tolerance to environmental stress and crop quality and yield. It should also be noted that a biostimulant's main role should not be to provide pesticidal activity.

For the avoidance of doubt, the composition may comprise both Aegle marmelos leaf particulate and an extract from Aegle marmelos leaf, the extract having been obtained with a solvent, such as an aqueous solvent.

The Aegle marmelos leaf particulate may comprise leaf particulate obtained from dry Aegle marmelos leaf. The leaf particulate is optionally formed by making particulate from dry leaf. It may be possible to form particulate from non-dried leaf, but typically the particulate is prepared from dry leaf.

Similarly, the solvent extract may be extracted from dry A.m. leaf. Alternatively, the solvent extract may be extracted from non-dried leaf. The A.m. leaf is optionally ground or otherwise machined to increase contact area with the solvent and optionally generate a range of particle sizes including nanoparticles.

If the composition comprises the leaf particulate, then in certain embodiments, the biostimulant composition may comprise at least 10 mg of leaf particulate per litre composition, optionally at least 50 mg/litre, optionally at least 100 mg/litre, optionally at least 200 mg/litre, optionally at least 300 mg/litre, optionally at least 400 mg/litre, optionally at least 500 mg/litre, optionally at least 750 mg/litre, optionally at least 1000 mg/litre, optionally at least 2000 mg/litre and optionally at least 3000 mg of leaf particulate per litre composition.

The composition may comprise a carrier liquid in which the leaf particulate and/or extract is dispersed. Alternatively, the composition may have no such carrier liquid, in which case the composition may be substantially dry (i.e. does not contain a liquid). This may be the case, for example, if the composition comprises said leaf particulate. The composition may consist essentially of said leaf particulate. Alternatively, the composition may comprise components in addition to said leaf particulate.

In some embodiments, the composition may comprise no more than 1000000 mg of leaf particulate per litre composition. In some embodiments, the biostimulant composition may comprise no more than 50000 mg of leaf particulate per litre composition In some embodiments, the biostimulant composition may comprise no more than 20000 mg of leaf particulate per litre composition, optionally no more than 15000 mg/litre, optionally no more than 10000 mg/litre, optionally no more than 7500 mg/litre and optionally no more than 5000 mg of leaf particulate per litre composition.

In some embodiments, the composition may comprise from 100 mg to 10000 mg of leaf particulate per litre composition, optionally from 200 mg/litre to 5000 mg/litre and optionally from 500 mg to 2000 mg per litre composition.

If the composition comprises the leaf extract, then in some embodiments, the solvent used to obtain the extract comprises water. The solvent may optionally comprise at least 1% water by volume, 5% water, optionally at least 10% water, optionally at least 20% water, optionally at least 30% water, optionally at least 40% water, optionally at least 50% water, optionally at least 60% water, optionally at least 70% water, optionally at least 80% water, optionally at least 90% water, optionally at least 95% water, optionally at least 98% water and optionally at least 99% water by volume. The solvent may consist of water.

In some embodiments, the solvent may optionally comprise no more than 99% water by volume, optionally no more than 98% water, optionally no more than 95% water, optionally no more than 90% water, optionally no more than 80% water, optionally no more than 70% water, optionally no more than 60% water, optionally no more than 50% water, optionally no more than 40% water, optionally no more than 30% water, optionally no more than 20% water, optionally no more than 10% water and optionally no more than 5% water by volume.

In some embodiments, the solvent may comprise one or more co-solvent. The one or more col-solvent is optionally miscible with water in the amounts used. The solvent may comprise at least 1% co-solvent by volume, optionally at least 2% co-solvent, optionally at least 5% co-solvent, optionally at least 10% co-solvent, optionally at least 20% co-solvent, optionally at least 30% co-solvent, optionally at least 40% co-solvent, optionally at least 50% co-solvent, optionally at least 60% co-solvent, optionally at least 70% co-solvent, optionally at least 80% co-solvent, optionally at least 90% co-solvent and optionally at least 95% co-solvent by volume.

In some embodiments, the solvent may comprise no more than 99% co-solvent by volume, optionally no more than 98% co-solvent, 95% co-solvent, optionally no more than 90% co-solvent, optionally no more than 80% co-solvent, optionally no more than 70% co-solvent, optionally no more than 60% co-solvent, optionally no more than 50% co-solvent, optionally no more than 40% co-solvent, optionally no more than 30% co-solvent, optionally no more than 20% co-solvent, optionally no more than 10% co-solvent and optionally no more than 5% co-solvent by volume.

In some embodiments, the solvent optionally comprises from 5% to 95% water by volume and from 5% to 95% co-solvent by volume, optionally from 10% to 90% water and from 10% to 90% co-solvent. Typically, the amount of water and co-solvent totals 100%. The solvent optionally comprises from 15% to 85% water by volume and from 15% to 85% co-solvent by volume. The solvent optionally comprises from 10% to 30% water by volume and from 70% to 90% co-solvent by volume. The solvent optionally comprises from 70% to 90% water by volume and from 10% to 30% co-solvent by volume.

The statements above refer to the composition comprising a defined %. For the avoidance of doubt, this is % by volume, unless the context dictates otherwise.

In some embodiments, the one or more co-solvent may comprise one or more alcohols, optionally one or more short-chain alcohols, optionally one or more alcohols comprising from one to four carbon atoms, optionally one or more primary alcohols. The one or more co-solvent optionally comprises one or more of methanol, ethanol and propanol (optionally n-propanol or i-propanol).

The solvent may comprise a eutectic solvent. The solvent may comprise a deep eutectic solvent. The deep eutectic solvent may comprise a quaternary ammonium species, such as choline. The counter ion for the quaternary ammonium species may comprise any suitable counter ion, including chloride or bitartrate.

If the composition comprises the extract, then in some embodiments, the composition may comprise at least 0.01 wt % extract, optionally at least 0.05 wt % extract, optionally at least 0.1 wt % extract, optionally at least 0.2 wt % extract, optionally at least 0.4 wt % extract, optionally at least 0.5 wt % extract, optionally at least 0.75 wt % extract, optionally at least 1.0 wt % extract, optionally at least 1.5 wt % extract and optionally at least 2.0 wt % extract.

In some embodiments, the composition may comprise no more than 10 wt % extract, optionally no more than 7.5 wt % extract, optionally no more than 5.0 wt % extract, optionally no more than 4.0 wt % extract, optionally no more than 3.0 wt % extract, optionally no more than 2.0 wt % extract and optionally no more than 1.0 wt % extract.

In some embodiments, the composition may comprise from 0.1 wt % to 10 wt % extract, optionally from 0.2 wt % to 5.0 wt %, and optionally from 0.4 wt % to 2.0 wt % extract.

If the composition comprises leaf particulate, the leaf particulate may optionally comprise particles having a greatest dimension of no more than 5 microns. Larger particles may also be present. For example, the leaf particulate may optionally comprise particles having a greatest dimension of up to 10 mm. The leaf particulate may optionally comprise particles having a greatest dimension of no more than 100 nm. The leaf particulate may optionally comprise particles having a greatest dimension of from 1 to 100 nm. Without wishing to be bound by theory, it is believed that leaf particulate having a greatest dimension of the order of 1-100 nm are advantageous because they may be translocated by plants.

In some embodiments, the composition optionally comprises a further biostimulant component i.e. a biostimulant component in addition to the A.m. leaf extract and/or A.m. leaf particulate. The further biostimulant component may comprise any suitable component, such as one or more of sugar cane molasses, beet molasses, amino acids, seaweed extracts, trace elements, ascorbic acid, humic acid, fulvic acid, potassium, nitrogen and phosphorus fertilisers, salicylic acid, surfactants, chitin, chitosan, vermicompost, algae extracts, phosphites, silicon, plant hormones, protein hydrolysatesorthosilicic acid and glycine betaine, and extracts therefrom. The composition may optionally comprise an extract from a plant other than A.m. For example, the composition may comprise an extract from an orange plant. The composition may optionally comprise orange terpenes.

In some embodiments, the composition optionally comprises orthosilicic acid. Orthosilicic acid typically forms at a pH of less than 9, and orthosilicic acid may be formed by diluting a silicate. As used herein, the term “silicate” encompasses all sources of silicate and silicate derivatives, including, for example, metasilicates, and pyrosilicates. It will be appreciated that silicate anions are often large polymeric molecules with an extensive variety of structures, including chains, rings, double chains and sheets.

In some embodiments, the composition optionally comprises one or more weak acids, such as one or more of phosphoric acid, acetic acid, citric acid, salicylic acid, tartaric acid, ascorbic acid, humic acid or fulvic acid.

In some embodiments, the composition may comprise one or more amino acids, such as tyrosine and/or phenylalanine.

In some embodiments, the composition may comprise a surfactant.

The composition may comprise a liquid carrier. The liquid carrier optionally comprises water, and optionally consists essentially of water. Those skilled in the art will realise that the water so used may be derived from any suitable water source, such as rainwater.

The composition may comprise at least 90 wt % liquid carrier, optionally at least 95 wt % liquid carrier and optionally at least 97 wt % liquid carrier.

The composition may comprise one or more pesticides, such as one or more of an insecticide, a fungicide and a nematicide. The one or more insecticide may be chosen from the list of insecticides recited on page 3 of WO2012/152737. The one or more fungicide may be chosen from the list of fungicides recited on page 3 of WO2012/152737. The one or more nematicide may be chosen from the list of insecticides recited on page 3 of WO2012/152737.

According to a second aspect of the invention there is also provided a method of treating an area comprising one or more plants and/or plant propagation material, the method comprising applying to said area Aegle marmelos leaf particulate or an extract from Aegle marmelos leaf, the extract having been obtained with a solvent.

The method may comprise applying to said area a composition in accordance with the first aspect of the present invention. The A.m. leaf and/or extract may be mixed with a carrier liquid. The leaf extract may therefore be applied in a diluted or dispersed form.

For the avoidance of doubt, the method may comprise applying to said area Aegle marmelos leaf particulate and an extract from Aegle marmelos leaf, the extract having been obtained with a solvent.

The solvent may be a polar solvent. The solvent may be an aqueous solvent i.e. a solvent comprising water.

The one or more plants or plant propagation material may comprise, or be derived from, a monocotyledon, such as ryegrass, or a dicotyledon, such as lettuce. The method may comprise applying A.m. leaf particulate or the optionally diluted leaf extract to one or more plants or plant propagation material, and/or to substrate in which the one or more plants or plant propagation material is located. In this case, the A.m. leaf particulate and/or optionally diluted extract contacts the plants or propagation material.

The A.m. leaf particulate and/or optionally diluted extract may be provided in a wash or spray, for example.

The method may comprise applying the A.m. leaf particulate and/or optionally diluted extract to individual growth receptacles or pots.

The method may comprise adding the A.m. leaf particulate and/or optionally diluted extract to an irrigation supply, a soil drench or a foliar spray.

If the method comprises applying A.m. leaf particulate, then the method may comprise applying at least 1 g of said leaf particulate per hectare, optionally at least 5 g per hectare, optionally at least 10 g per hectare, optionally at least 20 g per hectare, optionally at least 30 g per hectare, optionally at least 50 g per hectare, optionally at least 100 g per hectare, optionally at least 200 g per hectare, optionally at least 300 g per hectare, optionally at least 400 g per hectare, optionally at least 500 g per hectare, optionally at least 1000 g per hectare.

If the method comprises applying A.m. leaf particulate, then the method may comprise applying no more than 100 kg of said leaf particulate per hectare, optionally no more than 80 kg per hectare, optionally no more than 60 kg per hectare, optionally no more than 50 kg per hectare, optionally no more than 30 kg per hectare, optionally no more than 20 kg per hectare, optionally no more than 10 kg per hectare and optionally no more than 5 kg per hectare.

If the method comprises applying A.m. leaf particulate, then the method may comprise applying from 1 g to 100 kg of said leaf particulate per hectare, optionally from 50 g to 50 kg per hectare, optionally from 100 g to 10 kg per hectare and optionally from 1000 g to 10 kg per hectare.

If the method comprises applying a composition in accordance with a first aspect of the present invention, then the method may comprise applying at least 0.005 litres of the composition per hectare of the area, optionally at least 0.01 litres, optionally at least 0.02 litres, optionally at least 0.05 litres, optionally at least 0.1 litres, optionally at least 0.2 litres, optionally at least 0.3 litres, optionally at least 0.5 litres, optionally at least 0.8 litres, optionally at least 1.0 litres and optionally at least 2.0 litres of the composition per hectare of the area.

If the method comprises applying a composition in accordance with a first aspect of the present invention, then the method may comprise applying up to 100 litres of the composition per hectare of the area, optionally up to 80 litres, optionally up to 60 litres, optionally up to 50 litres, optionally up to 30 litres, optionally up to 20 litres and optionally up to 10 litres of the composition per hectare of the area.

If the method comprises applying a composition in accordance with a first aspect of the present invention, then the method may comprise applying from 0.005 to 100 litres of the composition per hectare of the area. The method may optionally comprise applying from 0.01 to 50 litres, optionally from 0.05 to 50 litres, optionally from 0.1 to 50 litres, optionally from 0.5 to 20 litres, optionally from 1 to 10 litres, optionally from 2 to 9 litres, optionally from 3 to 8 litres, optionally from 3 to 7 litres, optionally from 3 to 6 litres and optionally from 3 to 5 litres of the composition per hectare of the area. The amounts notes above relate to the one application of composition.

As noted below, the method may comprise applying the A.m. leaf particulate and/or optionally diluted extract more than once, the second and subsequent applications typically being spaced in time from previous applications. The method may comprise applying the A.m. leaf particulate and/or optionally diluted extract once, and only once.

The method may comprise applying the A.m. leaf particulate and/or optionally diluted extract to the area at least once every three years, optionally at least once every two years, optionally at least once every year, optionally at least once every nine months, optionally at least once every six months, optionally at least once every four months, optionally at least once every three months, optionally at least once every two months, optionally at least once a month, optionally more than once per month, optionally at least once a week and optionally at least once a day.

The method may comprise applying the A.m. leaf particulate and/or optionally diluted extract to the area more than once a month and optionally at least once a week for a period of at least one month, optionally for a period of at least six weeks and optionally for a period of at least two months.

The method may comprise applying the A.m. leaf particulate and/or optionally diluted extract to the area more than once a day. The method may comprise applying the A.m. leaf particulate and/or optionally diluted extract multiple times in a first day and subsequently applying the A.m. leaf particulate and/or optionally diluted extract multiple times in a second day. The second day may be at least two days, optionally at least three days and optionally at least five days after the first day. The method may comprise applying the A.m. leaf particulate and/or optionally diluted extract multiple times in a third day. The third day may be at least two days, optionally at least three days and optionally at least five days after the second day.

The method may comprise treating the area with one or more pesticides, such as those described above in relation to the composition of the first aspect of the present invention.

According to a third aspect of the present invention, there is provided use of Aegle marmelos leaf particulate or an extract from Aegle marmelos leaf, the extract having been obtained with a solvent, as a biostimulant.

The solvent may be a polar solvent. The solvent may be an aqueous solvent i.e. may comprise water.

The use of the third aspect of the present invention may comprise those features described above in relation to the composition of the first aspect of the present invention and/or in relation to the method of the second aspect of the present invention. For example, the use of the Aegle marmelos leaf particulate or said extract from Aegle marmelos leaf may be in association with one or more of the other optional components listed above in relation to the composition of the first aspect of the present invention. For example, the use of the Aegle marmelos leaf particulate or said extract from Aegle marmelos leaf may be in association with one or more further biostimulant. The use of Aegle marmelos leaf particulate or said extract from Aegle marmelos leaf may be in addition to another use of Aegle marmelos leaf particulate or said extract from Aegle marmelos leaf. As mentioned above, the use of the third aspect of the present invention may comprise one or more features of the method of the second aspect of the present invention. For example, the use may comprise using the Aegle marmelos leaf particulate or said extract from Aegle marmelos leaf with a carrier liquid.

According to a fourth aspect of the present invention, there is provided a biostimulant comprising Aegle marmelos leaf particulate or an extract from Aegle marmelos leaf, the extract having been obtained with a solvent. For the avoidance of doubt, the biostimulant may comprise both Aegle marmelos leaf particulate and an extract from Aegle marmelos leaf, the extract having been obtained with a solvent.

According to a fifth aspect of the present invention, there is provided Aegle marmelos leaf particulate or an extract from Aegle marmelos leaf, the extract having been obtained with a solvent, for use as a biostimulant.

The Aegle marmelos leaf particulate or said extract from Aegle marmelos leaf may be identified and/or labelled for use as a biostimulant.

For the avoidance of doubt, the solvent used in the fourth, fifth and sixth aspects of the present invention may be a polar solvent. The solvent may be an aqueous solvent i.e. the solvent comprises water. The solvent may be as defined in relation to the composition of the first aspect of the present invention.

According to a sixth aspect of the present invention, there is provided a pre-composition comprising Aegle marmelos leaf particulate or an extract from Aegle marmelos leaf, the extract having been obtained with a solvent. For the avoidance of doubt, the pre-composition may comprise both Aegle marmelos leaf particulate and an extract from Aegle marmelos leaf, the extract having been obtained with a solvent.

The pre-composition is suitable for mixing with a carrier liquid, optionally to form a biostimulant composition, such as a biostimulant composition in accordance with the first aspect of the present invention. The pre-composition may comprise one or more features of the composition of the first aspect of the present invention.

The solvent may be a polar solvent. The solvent may be an aqueous solvent i.e. the solvent comprises water. The solvent may be as defined in relation to the composition of the first aspect of the present invention.

The pre-composition is optionally provided with instructions for forming a biostimulant composition, optionally a biostimulant composition in accordance with the first aspect of the present invention. The pre-composition may comprise one or more pesticides, such as those described above in relation to the composition of the first aspect of the present invention.

The pre-composition may have a total polyphenol content as measured against a Gallic acid standard of at least 0.20 mg GAE/ml, optionally at least 0.50 mg GAE/ml, optionally at least 0.75 mg GAE/ml, optionally at least 1.0 mg GAE/ml, optionally at least 1.5 mg GAE/ml, and optionally at least 2.0 mg GAE/ml.

The pre-composition may have a DPPH TROLOX equivalent free radical scavenging capacity of at least 2.0 μmol TROLOX eq/ml, optionally at least 3.0 μmol TROLOX eq/ml, optionally at least 5.0 μmol TROLOX eq/ml, optionally at least 8.0 μmol TROLOX eq/ml, optionally at least 10 μmol TROLOX eq/ml and optionally at least 15 μmol TROLOX eq/ml.

The pre-composition may have a ABTS TROLOX equivalent free radical scavenging capacity of at least 5.0 μmol TROLOX eq/ml, optionally at least 10 μmol TROLOX eq/ml, optionally at least 12 μmol TROLOX eq/ml and optionally at least 15 μmol TROLOX eq/ml.

According to a seventh aspect of the present invention, there is provided a package containing a pre-composition in accordance with the sixth aspect of the present invention. The package may be provided with instructions for forming a biostimulant composition, optionally a biostimulant composition in accordance with the first aspect of the present invention, optionally by mixing the pre-composition in accordance with the sixth aspect of the present invention with a carrier liquid. The package may be provided with instructions for using the biostimulant composition so formed, optionally in accordance with a method in accordance with the present invention.

According to an eighth aspect of the present invention, there is provided a package containing a composition in accordance with the first aspect of the present invention. The package may be provided with instructions for using the composition, optionally in accordance with a method in accordance with the present invention.

According to a ninth aspect of the present invention, there is provided a substrate for supporting the growth of plants and/or plant propagation material, the substrate comprising Aegle marmelos leaf particulate and/or an extract from Aegle marmelos leaf, the extract having been obtained with a solvent, optionally a polar solvent and optionally an aqueous solvent (i.e. a solvent comprising water).

The A.m. leaf particulate may have those features described above in relation to the first to eighth aspects of the present invention, in particular in relation to the composition of the first aspect of the present invention.

The substrate may comprise a particulate material, such as compost. The substrate may comprise suitable growth-enhancing components, such as one or more additional biostimulants, such as those described above in relation to the first to eighth aspects of the present invention.

If the substrate comprises A.m. leaf particulate, then the substrate may comprise at least 0.001 g of said leaf particulate per kg of substrate, optionally at least 0.005 g per kg, optionally at least 0.01 g per kg, optionally at least 0.02 g per kg, optionally at least 0.05 g per kg, optionally at least 0.1 g per kg, optionally at least 0.5 g per kg and optionally at least 1.0 g of said leaf particulate per kg of substrate.

If the substrate comprises A.m. leaf particulate, then the substrate may comprise no more than 100 g of said leaf particulate per kg of substrate, optionally no more than 80 g per kg, optionally no more than 60 g per kg, optionally no more than 50 g per kg, optionally no more than 40 g per kg, optionally no more than 30 g per kg, optionally no more than 20 g per kg and optionally no more than 10 g of said leaf particulate per kg of substrate.

If the substrate comprises A.m. leaf particulate, then the substrate optionally comprises from 0.01 g to 100 g of said leaf particulate per kg of substrate, optionally from 0.1 g to 80 g per kg, optionally from 0.5 g to 50 g per kg of said leaf particulate per kg of substrate.

In accordance with a tenth aspect of the present invention, there is provided a method of making a biostimulant, the method comprising:

Producing Particulate from One or More Aegle marmelos Leaves.

The one or more leaves may be dry or dried.

The particulate may be used, or for use, as a biostimulant. The particulate so made may be used in the first to ninth aspects of the present invention.

The one or more leaves may be Aegle marmelos leaves.

The particulate may have the features and/or characteristics as described above in relation to the first to ninth aspects of the present invention.

The method may comprise producing dry leaf particulate from one or more leaves.

The method may comprise producing particulate from one or more leaves in the presence of a liquid.

The method may comprise producing a first, dry, leaf particulate from one or more leaves, and subsequently producing leaf particulate from the first leaf particulate in the presence of a liquid.

Producing particulate from one or more leaves may comprise use of a blender, for example.

The method of the tenth aspect of the present invention may be used to produce the leaf particulate used in the first to ninth aspects of the present invention.

The leaf particulate produced by the method of the tenth aspect of the present invention may be used as a biostimulant. In accordance with an eleventh aspect of the present invention, there is therefore provided a biostimulant comprising leaf particulate. The leaf particulate may be made using the method of the tenth aspect of the present invention. The biostimulant in accordance with the eleventh aspect of the present invention may be used instead of Aegle marmelos leaf in the first to ninth aspects of the present invention.

It will, of course, be appreciated that features described in relation to one aspect of the present invention may be incorporated into other aspects of the present invention. For example, the method of the invention may incorporate any of the features described with reference to the composition of the invention and vice versa.

The Aegle marmelos leaves were obtained from Rajasthan in India. Those skilled in the art will realise that Aegle marmelos leaves may be obtained from other countries.

Embodiments of the present invention will now be described by way of example only.

### DETAILED DESCRIPTION

### Composition Example 1—Composition Comprising Leaf Particulate (1 g/Litre)

A mass of dry, brittle A.m. leaves were processed using a blender. A known mass of usable dry material was then added to water, and the suspension of leaf particulate in water was processed further using the blender in order to reduce the particle size further. Further water was added so that the leaf loading was 1 g of leaf per litre of water.

### Composition Example 2—Composition Comprising Leaf Particulate (2 g/Litre)

Composition Example 2 was made in the same manner as Composition Example 1, but ensuring that the leaf loading was 2 g of leaf per litre of water.

### Composition Example 3—Composition Comprising Leaf Particulate (4 g/l)

Composition Example 3 was made in the same manner as Composition Example 1, but ensuring that the leaf loading was 4 g of leaf per litre of water.

### Composition Example 4—Composition Comprising Leaf Extract Obtained Using 80% Water, 20% Ethanol, Dilution 100:1

A known mass of dry, brittle A.m. leaf was processed using a blender. 50 g of the processed leaf was added to 320 ml of a solvent comprising a mixture of 80% water: 20% ethanol, and the solvent and leaf were agitated for about 5 hours at ambient temperature. The extract was then diluted with water, with 100 parts of water to 1 part of the extract, to provide Composition Example 4.

### Composition Example 5—Composition Comprising Leaf Extract Obtained Using 20% Water, 80% Ethanol, Dilution 100:1

A known mass of dry, brittle A.m. leaf was processed using a blender. 50 g of the processed leaf was added to 320 ml of a mixture of 20% water: 80% ethanol, and the solvent and leaf were agitated for about 5 hours at ambient temperature. The extract was then diluted with water, with 100 parts of water to 1 part of the extract, to provide Composition Example 5.

### Composition Example 6—Composition with Leaf Particulate, Ascorbic Acid and Orthosilicic Acid

A mass of dry, brittle A.m. leaves were processed using a blender. A known mass of usable dry material was then added to water, and the suspension of leaf particulate in water was processed further using the blender in order to reduce the particle size further. Further water was added so that the leaf loading was 33 g of leaf per litre of water. Ascorbic acid was added to a concentration of 20 g per litre of water. The solution of ascorbic acid/suspension of A.m. leaf was mixed with an equal volume of a 23 g/litre solution of liquid sodium silicate in water. The mixture was stirred and allowed to stand for at least 4 hours. A 300 micron sieve was used to filter the mixture, with material left on the sieve being discarded. The resulting liquid is stable for at least 5 days. The liquid is then diluted with water to give a leaf loading of 1 g/litre.

Without wishing to be bound by theory, it is believed that at least some of the A.m. particulate is present on a nanometer scale (approximately up to about 100 nm) and that interaction is taking place between the silicon species that are present and the nanometer scale A.m. particulate that is present. Evidence for this is that the composition is stable over a relatively long time scale, and gelling does not occur. It is thought that if no nanometer scale A.m. particulate is present, then there would be no such interaction between the silicon species and nanometer scale A.m. leaf particulate, in which case gelling of the silicon species would occur over a timescale of a few hours. Such gelling is not observed. As described below, it is further observed that Composition Example 6 demonstrates improved biostimulant activity compared to A.m. leaf particulate alone, indicating interaction between the A.m. leaf particulate and the silicon species that helps stabilise the silicon species and inhibits gelling.

### Composition Example 7—Composition with Leaf Particulate and Maxstim (a Biostimulant Composition Comprising Amino Acids, Organic Acids, Trace Elements and Sugar Cane Molasses)

Two grams of A.m. leaf particulate was added to a solution comprising 2 g Maxstim biostimulant composition in approximately 250 ml of water. The resulting suspension was blended using a blender to reduce the size of the leaf particulate further. Further water was then added to make the composition up to 1 litre.

### Method Example 1—CE 1 on Butterhead Lettuce (Lactuca sativa)

6 ml of Composition Example 1 were administered on day 1 to each of five 4″ (102 mm) diameter pots filled with substrate (J Arthur Bowers compost) and provided with 5 lettuce seeds. 6 ml of Composition Example 1 were further administered on days 7, 14 and 21.

### Method Example 2—CE 3 on Lettuce

6 ml of Composition Example 3 were administered on day 1 to each of five 4″ (102 mm) diameter pots, each pot being filled with substrate and provided with five lettuce seeds. 6 ml of Composition Example 3 were further administered on days 7, 14 and 21.

### Method Example 3—CE 4 on Lettuce

6 ml of Composition Example 4 were administered on day 1 to each of five 4″ (102 mm) diameter pots, each pot being filled with substrate and provided with five lettuce seeds. 6 ml of Composition Example 4 were further administered on days 7, 14 and 21.

### Method Example 4—CE 5 on Lettuce

6 ml of Composition Example 5 were administered on day 1 to each of five 4″ (102 mm) diameter pots, each pot being filled with substrate and provided with five lettuce seeds. 6 ml of Composition Example 5 were further administered on days 7, 14 and 21.

### Control for Method Examples 1-4—Water

6 ml of water were administered on day 1 to each of five 4″ (102 mm) diameter pots, each pot being filled with substrate and provided with five lettuce seeds. 6 ml of water were further administered on days 7, 14 and 21.

### Comments on Method Examples 1-4 (“AM Extracts on Lettuce”)

The growth of the lettuce plants was observed after 28 days and 40 days for Method Examples 1-4 and the associated control mentioned above. After 28 and 40 days the mass of plants generated by each of Method Examples 1-4 was noticeably greater than the mass generated by the control, as determined by eye. Furthermore, the mass of plants generated by each of Method Examples 1 and 2 was noticeably greater than the mass generated by Method Examples 3 and 4, indicating that the particulate of A.m. leaf provides superior biostimulant properties to either of the water/ethanol extracts.

### Method Example 5—CE 1 on Rye Grass

6 ml of Composition Example 1 were administered on day 1 to each of five 4″ (102 mm) diameter pots filled with substrate and which had been provided with 3 g of rye grass seeds. 6 ml of Composition Example 1 were further administered on days 7, 14 and 21.

### Method Example 6—CE 2 on Rye Grass

6 ml of Composition Example 2 were administered on day 1 to each of five 4″ (102 mm) diameter pots filled with substrate and which had been provided with 3 g rye grass seeds. 6 ml of Composition Example 2 were further administered on days 7, 14 and 21.

### Method Example 7—CE 4 on Rye Grass

6 ml of Composition Example 4 were administered on day 1 to each of five 4″ (102 mm) diameter pots filled with substrate and which had been provided with 3 g rye grass seeds. 6 ml of Composition Example 4 were further administered on days 7, 14 and 21.

### Method Example 8—CE 5 on Rye Grass

6 ml of Composition Example 5 were administered on day 1 to each of five 4″ (102 mm) diameter pots filled with substrate and which had been provided with 3 g rye grass seeds. 6 ml of Composition Example 5 were further administered on days 7, 14 and 21.

### Control for Method Examples 5-8—Water

6 ml of water were administered on day 1 to each of five 4″ (102 mm) diameter pots filled with substrate and which had been provided with 3 g rye grass seeds. 6 ml of water were further administered on days 7, 14 and 21.

### Comments on Method Examples 5-8 (“AM Extracts on Rye Grass”)

The biomass was measured on day 28 for rye grass treated as described in Method Examples 5-8 and for the associated control, and the results are shown in Table 1.

TABLE 1
biomass generated by treatment with particulate A.m. leaf or extracts

| Treatment method | Total biomass from the 5 pots (g) |
|---|---|
| Method Example 5 | 69.6 |
| Method Example 6 | 64.8 |
| Method Example 7 | 63.3 |
| Method Example 8 | 62.8 |
| Control | 46.2 |

The results from Table 1 show that both particulate A.m. leaf and water/ethanol extracts are effective biostimulants for rye grass. The results from Table 1 also suggest that particulate A.m. leaf is a slightly more effective stimulant that the water/ethanol extracts in relation to rye grass.

### Method Example 9—CE 6 on Lettuce

6 ml of Composition Example 6 were administered on day 1 to each of five 4″ (102 mm) diameter pots, each pot having been filled with substrate and provided with five lettuce seeds. 6 ml of Composition Example 6 were further administered on days 7, 14 and 21.

### Control 1 for Method Example 9—OSA Only

6 ml of ortho silicic acid solution (i.e. the composition of Composition Example 6 without the A.m. leaf particulate) were administered on day 1 to each of five 4″ (102 mm) diameter pots, each pot being filled with substrate and having been provided with five lettuce seeds. 6 ml of the ortho silicic acid solution were further administered on days 7, 14 and 21.

### Control 2 for Method Example 9—Water Only

6 ml of water were administered on day 1 to each of five 4″ (102 mm) diameter pots, each pot being filled with substrate and provided with five lettuce seeds. 6 ml of water were further administered on days 7, 14 and 21

The growth of the lettuce plants was observed after 28 days and 40 days for Method Example 9, Method Example 1 and the associated two controls mentioned above. After 28 and 40 days, the mass of plants generated by each of Method Examples 1 and 9 and Control 1 for Method Example 9 was noticeably greater, when compared by eye, than the mass generated by the Control 2 for Method Example 9. Furthermore, the mass of plants generated by Method Example 9 was noticeably greater, when compared by eye, than the mass generated by Method Example 1 and Control 1 for Method Example 9, indicating that the combination of particulate A.m. leaf and ortho silicic acid provides superior biostimulant properties to particulate A.m. leaf alone.

### Method Example 10—CE 6 on Rye Grass

6 ml of Composition Example 6 were administered on day 1 to each of five 4″ (102 mm) diameter pots filled with substrate and having been provided with 3 g rye grass seeds. 6 ml of Composition Example 6 were further administered on days 7, 14 and 21.

### Control 1 for Method Example 10—OSA Only

6 ml of ortho silicic acid solution (i.e. the composition of Composition Example 6 without the A.m. leaf particulate) were administered on day 1 to each of five 4″ (102 mm) diameter pots filled with substrate and having been provided with 3 g rye grass seeds. 6 ml of the ortho silicic acid solution were further administered on days 7, 14 and 21.

### Control 2 for Method Example 9—Water Only

6 ml of water were administered on day 1 to each of five 4″ (102 mm) diameter pots filled with substrate and having been provided with 3 g rye grass seeds. 6 ml of water were further administered on days 7, 14 and 21.

The biomass was measured on day 28 for rye grass treated as described in Method Examples 10 and for the associated controls, and the results are shown in Table 2.

TABLE 2
biomass generated by treatment with particulate
A.m. leaf and ortho silicic acid

| Treatment method | Total biomass from the 5 pots (g) |
|---|---|
| Method Example 10 | 68.1 |
| Control 1 | 56.9 |
| Control 2 | 46.2 |

The results from Table 2 show that particulate A.m. leaf and orthosilicic acid together provide a biostimulant effect that is superior to orthosilicic acid alone.

### Method Example 11—CE 7 on Lettuce

6 ml of Composition Example 7 were administered on day 1 to each of five 4″ (102 mm) diameter pots, each pot being filled with substrate and provided with five lettuce seeds. 6 ml of Composition Example 7 were further administered on days 7, 14 and 21.

### Control 1 for Method Example 11—Maxstim Only

6 ml of MX solution (i.e. the composition of Composition Example 7 without the A.m. leaf particulate) were administered on day 1 to each of five 4″ (102 mm) diameter pots, each pot being filled with substrate and provided with five lettuce seeds. 6 ml of the MX solution were further administered on days 7, 14 and 21.

### Control 2 for Method Example 11—Water Only

6 ml of water were administered on day 1 to each of five 4″ (102 mm) diameter pots, each pot being filled with substrate and provided with five lettuce seeds. 6 ml of water were further administered on days 7, 14 and 21

The growth of the lettuce plants was observed after 40 days for Method Example 11, Method Example 1 and the associated two controls mentioned above. After 40 days, the mass of plants generated by each of Method Examples 1 and 11 and Control 1 for Method Example 11 was noticeably greater, by eye, than the mass generated by the Control 2 for Method Example 11. Furthermore, the mass of plants generated by Method Example 11 was noticeably greater, by eye, than the mass generated by Method Example 1 and Control 1 for Method Example 11, indicating that the combination of particulate A.m. leaf and MX provides superior biostimulant properties to particulate A.m. leaf alone and to MX alone.

### Method Example 12—CE 7 on Rye Grass

6 ml of Composition Example 7 were administered on day 1 to each of five 4″ (102 mm) diameter pots filled with substrate and provided with rye grass seeds. 7 ml of Composition Example 7 were further administered on days 7, 14 and 21.

### Control 1 for Method Example 12—Maxstim Only

6 ml of MX solution (i.e. the composition of Composition Example 7 without the A.m. leaf particulate) were administered on day 1 to each of five 4″ (102 mm) diameter pots filled with substrate and provided with rye grass seeds. 6 ml of the MX solution were further administered on days 7, 14 and 21.

### Control 2 for Method Example 12—Water Only

6 ml of water were administered on day 1 to each of five 4″ (102 mm) diameter pots filled with substrate and provided with rye grass seeds. 6 ml of water were further administered on days 7, 14 and 21.

The biomass was measured on day 28 for rye grass treated as described in Method Example 12 and for the associated controls, and the results are shown in Table 3.

TABLE 3
biomass generated by treatment with particulate A.m. leaf and MX

| Treatment method | Total biomass from the 5 pots (g) |
|---|---|
| Method Example 12 | 66.3 |
| Control 1 | 56.3 |
| Control 2 | 46.2 |

The results from Table 3 show that particulate A.m. leaf and MX solution together provide a biostimulant effect that is superior to MX solution alone.

Note that the methods described above illustrate the use of A.m. leaf particulate and aqueous extracts of A.m. leaf as a biostimulant.

### Substrate Example 1

5 g of dry ground A.m. leaf particulate was spread evenly over the surface of 1.5 kg (4 litres) of Westland organic compost that had been spread over a smooth surface to a depth of no more than 1 cm. The compost was then gathered up, mixed and placed into a 4 litre capacity tray.

### Substrate Example 2

10 g of dry ground A.m. leaf particulate was spread evenly over the surface of 1.5 kg (4 litres) of Westland organic compost that had been spread over a smooth surface to a depth of no more than 1 cm. The compost was then gathered up, mixed and placed into a 4 litre capacity tray.

### Substrate Example 3

20 g of dry ground A.m. leaf particulate was spread evenly over the surface of 1.5 kg (4 litres) of Westland organic compost that had been spread over a smooth surface to a depth of no more than 1 cm. The compost was then gathered up, mixed and placed into a 4 litre capacity tray.

### Substrate Example 4

A master mix was made comprising 2 g per litre of ground A.m. leaf particulate per litre of 20% glycine betaine solution in water. The master mix was diluted by a factor of 40 to produce a diluted composition, and 100 ml of the diluted composition was mixed with 1.5 kg (4 litres) of Westland organic compost.

### Substrate Example 5

A master mix was made comprising 2 g per litre of ground A.m. leaf particulate per litre of 20% glycine betaine solution in water. The master mix was diluted by a factor of 40 to produce a diluted composition, and 200 ml of the diluted composition was mixed with 1.5 kg (4 litres) of Westland organic compost.

### Method Examples 13-17

1.5 litres of each of Substrate Examples 1-5 were put into a 4 litre tray and 20 g of rye grass seeds was scattered over each Substrate Example. The seeds were left to germinate and were watered as required. The mass of the rye grass grown was determined after 35 days and compared to a control. The results for Method Examples 13-17 are shown below in Table 4. The control was Westland organic compost.

TABLE 4
effect of treated substrate on biomass of rye grass

| Method Example No. | Substrate Example No. | % difference in biomass |
|---|---|---|
| 13 | 1 | 7 |
| 14 | 2 | 16 |
| 15 | 3 | 35 |
| 16 | 4 | 27 |
| 17 | 5 | 120 |

It can be seen from Method Examples 13-17 that providing a substrate with particulate A.m. leaves increases biomass.

GCMS Analysis of Particulate A.m. Leaves, Water/Alcohol Extract from A.m. Leaves and Water Extract from A.m. Leaves

GCMS analysis of particulate A.m. leaves, water/alcohol extract from A.m. leaves and water extract from A.m. leaves was undertaken and compared to GCMS results from A.m. essential oils.

### Sample Preparation

The water and alcohol/water extraction samples were centrifuged at 4500 rpm for 10 min at 4° C., before filtering through a 0.45 μm syringe filter (Whatman).

The GCMS samples from particulate leaf were prepared as follows. 1 g of particulate leaves were extracted as received by macerating with 80% methanol, 1% acetic acid followed by centrifuging at 4500 rpm for 10 min at 4° C. The sample was then reextracted and the extracts combined and made up to a known volume, before being passed through a 1 μm syringe filter. A dry matter analysis was also carried out on this sample.

Total polyphenol content was determined as follows. Samples were diluted to an appropriate concentration in methanol and analysed in triplicate by adding in 20 μl aliquots to individual wells in a 96 well plate. 100 μl of 2M Folin & Ciocalteu's reagent pre diluted 1:4 was then added to all wells and the plate shaken using a plate shaker for 4 min. 75 μl of 100 g/l Sodium Carbonate solution was then added to all wells and the plate shaken for a further 1 min using a plate shaker before an adhesive lid was applied.

The microplate was then incubated in the dark at room temperature for 2 hours before reading at 750 nm using a spectrophotometer. Results are expressed against a Gallic acid standard as mg GAE/ml in the case of the extracts and as mg GAE/g in the case of the particulate leaves.

DPPH TROLOX equivalent free radical scavenging capacity was measured as follows. Samples were diluted to an appropriate concentration in 80% methanol and analysed in triplicate by adding in 20 μl aliquots to individual wells in a 96 well plate. 2800 of 150 μmol/l DPPH radical working solution was then added to all wells and an adhesive lid applied before the plate was shaken using a plate shaker set at 350±50 rpm for 45 min.

The microplate was then read at 515 nm using a spectrophotometer. Antioxidant capacity was calculated as percentage of DPPH quenched relative to the reactivity of TROLOX as a standard under the same conditions. Results are expressed as μmol TROLOX eq/ml in the case of the extracts and as μmol TROLOX eq/g in the case of the particulate leaves.

ABTS TROLOX equivalent free radical scavenging capacity was determined as follows. Samples were diluted to an appropriate concentration in methanol and analysed in triplicate by adding in 20 μl aliquots to individual wells in a 96 well plate. 280 μl of ABTS radical cation working solution was then added to all wells and the plate shaken using an instrumental shaking method for 4 min. An adhesive lid was applied and the microplate incubated in the instrument at 28° C. for 30 min before reading at 734 nm. Antioxidant capacity was then calculated as percentage inhibition of ABTS relative to the reactivity of TROLOX as a standard under the same conditions. Results are expressed as μmol TROLOX eq/ml in the case of the extracts and as μmol TROLOX eq/g in the case of the particulate leaves.

LC-DAD-QTOF polyphenolic analysis was performed as follows. Polyphenolic analysis were performed on an Agilent 6510 QTOF mass spectrometer/Agilent 1200 HPLC system equipped with a diode array detector (DAD). Separation was achieved using a Phenomenex Luna 5μ C18(2) 100 Å LC (150 mm×2.0 mm) column operated at 30° C. The mobile phase consisted of 100% deionised water containing 1% formic acid (mobile phase A) and 100% Acetonitrile containing 1% formic acid (mobile phase B). A gradient program was employed where % B ranged from 1% to 100% over a runtime of 81 min. The flow rate was held at 0.2 ml/min and 50 of each sample was injected. Simultaneous monitoring of UV signals at 280, 320, 360 and 530 nm was carried out. Accurate mass data was also collected in negative ESI mode over a mass range of 100-1000 Da at a rate of 1.5 spectra/s.

The GCMS data showed that the A.m. essential oils had a very different chemical composition to the particulate A.m. leaves, water/alcohol extract from A.m. leaves and water extract from A.m. leaves. In this connection, the GCMS data obtained from the A.m. essential oils indicated the presence of significant amounts of terpenes (such as beta-carophylene) and flavonoid aglycones. The GCMS data obtained from particulate A.m. leaves and water/alcohol extract from A.m. leaves indicated the presence of a significant amount of polyphenols. In this connection, the water/alcohol extract yielded a total phenolic content as determined in gallic acid equivalents of 3.50 mg/ml, a DPPH TROLOX equivalent free radical scavenging capacity of 18.39 micromol/ml and an ABTS TROLOX equivalent anti-oxidant capacity of 20.74 micromol/ml. The particulate leaf (12.3% dry matter sample) yielded a total phenolic content as determined in gallic acid equivalents of 4.51 mg/ml, a DPPH TROLOX equivalent free radical scavenging capacity of 19.10 micromol/ml and an ABTS TROLOX equivalent anti-oxidant capacity of 38.43 micromol/ml. A water extract yielded a total phenolic content as determined in gallic acid equivalents of 0.35 mg/ml, a DPPH TROLOX equivalent free radical scavenging capacity of 1.65 micromol/ml and an ABTS TROLOX equivalent anti-oxidant capacity of 3.32 micromol/ml. The results obtained from the water/alcohol extract and the leaf particulate are particularly impressive, not least when compared to results generated from Bramley apple, a recognised source high in polyphenols (a 13.3% dry matter sample yielding a total phenolic content as determined in gallic acid equivalents of 1.50 mg/ml, a DPPH TROLOX equivalent free radical scavenging capacity of 9.21 micromol/ml and an ABTS TROLOX equivalent anti-oxidant capacity of 12.57 micromol/ml).

### Composition Example 8

A mass of dry, brittle A.m. leaves were processed using a blender. A known mass of usable dry material was then added to a volume of solvent comprising 20% ethanol:80% water mixture (vol:vol). The suspension of leaf particulate in solvent was processed further using the blender in order to reduce the particle size further. Further solvent was added to a dispersion concentration of 2 g of A.m. leaves per 100 ml solvent. The dispersion was then diluted by water 1000 parts water:1 part dispersion (vol:vol.), ready for use.

### Composition Example 9

Composition Example 9 was made as per Composition Example 8, but with 4 g of A.m. leaves per 100 ml solvent.

### Composition Example 10

Composition Example 10 was made as per Composition Example 8, but with 10 g of A.m. leaves per 100 ml solvent.

### Composition Example 11

A mass of dry, brittle A.m. leaves were processed using a blender. A known mass of usable dry material was then added to a volume of solvent comprising an emulsion of orange terpenes and water (2:1 vol.:vol.). The suspension of leaf particulate in solvent was processed further using the blender in order to reduce the particle size further. The sample was subject to 10 mins in an ultrasound bath to improve extraction. Further solvent was added to a dispersion concentration of 2 g of A.m. leaves per 100 ml solvent. The dispersion was then diluted by water 1000 parts water:1 part dispersion (vol:vol.), ready for use.

### Composition Example 12

A mass of dry, brittle A.m. leaves were processed using a blender. A known mass of usable dry material was then added to a volume of deep eutectic solvent. The deep eutectic solvent was made from choline bitartrate, glycerol and water mixed at the ratio 42:45:13 wt:wt. This was heated at 40° C. for 30 minutes to form a clear liquid. The suspension of leaf particulate in solvent was processed further using the blender in order to reduce the particle size further. The sample was subject to 10 mins in an ultrasound bath to improve extraction. Further solvent was added to a dispersion concentration of 2 g of A.m. leaves per 100 ml solvent. 2 ml of yucca extract was also added per 100 ml of solvent as a surfactant. The dispersion was then diluted by water 1000 parts water:1 part dispersion (vol:vol.), ready for use.

### Composition Example 13

Composition Example 13 was made as per Composition Example 12, but with 4 g of A.m. leaves per 100 ml solvent.

### Method Examples 18 to 23

6 ml of Composition Examples 8 to 13 were sprayed onto a pot comprising grass seeds in a growth substrate, once immediately after sowing, then 1 week post-sowing and 2 weeks post-sowing. Five pots were used per Composition Example. After several weeks, the leaf biomass of the five pots was measured by removing and weighing the leaves from the five pots. Root biomass was estimated visually for each pot on a scale of 1-5, and the scale estimations for the five pots were aggregated to give an overall score from 5 to 25. The results are shown below in Table 5.

TABLE 5
effect of treatment on leaf and root biomass

| Composition | Method Example | Leaf biomass of five | Root biomass |
|---|---|---|---|
| Example No. | No. | pots (g) | (5-25) |
| 8 | 18 | 23.3 | 21 |
| 9 | 19 | 28.2 | 18 |
| 10 | 20 | 68.7 | 22 |
| 11 | 21 | 56.0 | 13 |
| 12 | 22 | 46.5 | 9 |
| 13 | 23 | 46.2 | 8 |
| Control (water only) | N/A | 38.7 | 9 |

Table 5 shows that the use of higher amounts of A.m. leaf (Composition Example 10), the use of A.m. leaf with orange terpenes and the use of a deep eutectic solvent are effective. Furthermore, Table 5 also shows that treatment with smaller amounts of A.m. leaf may produce high root biomass (Composition Examples 8 and 9).

The total polyphenol content, DPPH TROLOX equivalent free radical scavenging capacity and ABTS TROLOX equivalent free radical scavenging capacity of the pre-compositions that were diluted to form Composition Examples 8-13 were measured and the results are shown below in Table 6. The pre-compositions were 1000 times more concentrated than the Composition Examples.

TABLE 6
measurement of some active components of pre-compositions that were
diluted to form some of Composition Examples 8-13

| | | DPPH | ABTS |
|---|---|---|---|
| | Total polyphenols | μmol TROLOXeq | μmol TROLOXeq |
| Composition | mg GAE/ml in pre- | /ml in pre- | /ml in pre- |
| Example No. | composition | composition | composition |
| 8 | 0.76 | 3.86 | 7.18 |
| 9 | 1.15 | 6.19 | 11.30 |
| 10 | 2.63 | 13.55 | 24.31 |
| 12 | n/a | 7.48 | 17.52 |
| 13 | n/a | 13.03 | 26.90 |

Whilst the present invention has been described and illustrated with reference to particular embodiments, it will be appreciated by those of ordinary skill in the art that the invention lends itself to many different variations not specifically illustrated herein. By way of example only, certain possible variations will now be described.

In the examples above, Indian A.m. leaves were used. Those skilled in the art will realise that A.m. leaves from other countries may be used.

In the examples above the leaf particulate is formed using a blender. Those skilled in the art will realise that other techniques may be used to form the particulate. For example, the leaf particulate may be formed by grinding.

In the examples above, the aqueous extract is formed using a solvent comprising water and ethanol. Those skilled in the art will realise that other solvents may be used. The solvent may typically comprise one or more alcohols.

In the examples above, lettuce and rye grass were treated. Those skilled in the art will realise that other plants may be treated.

The treatment methods described above used a regime of treatment at days 1, 7, 14 and 21 days (i.e. weekly). Those skilled in the art will realise that other treatment regimes are possible.

The examples above describe biostimulant compositions optionally comprising orthosilicic acid. Those skilled in the art will realise that other components may be added to the composition.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. A biostimulant plant treatment composition comprising Aegle marmelos leaf particulate and/or an extract from Aegle marmelos leaf, the extract having been obtained with a solvent.

2. The composition according to claim 1 comprising at least 100 mg of the Aegle marmelos leaf particulate per liter composition.

3. (canceled)

4. (canceled)

5. The composition according to claim 1 comprising the extract from Aegle marmelos leaf extract, the Aegle marmelos extract having been obtained with an aqueous solvent, the solvent comprising at least 10 vol % water.

6. (canceled)

7. The composition according to claim 1 comprising the extract from Aegle marmelos leaf, the composition comprising from water and one or more alcohols.

8. The composition according to claim 7 comprising Aegle marmelos leaf particulate.

9. The composition according to claim 1 comprising the extract from Aegle marmelos leaf, the Aegle marmelos extract having been obtained with a deep eutectic solvent, the composition comprising a deep eutectic solvent.

10. The composition according to claim 1 comprising the extract from Aegle marmelos leaf extract, the Aegle marmelos leaf extract having been obtained with a solvent, and the composition comprising at least 0.2 wt % extract, and optionally no more than 10 wt % extract.

11. (canceled)

12. The composition according to claim 1 comprising a further biostimulant component.

13. The composition according to claim 1 comprising one or more of: orthosilicic acid;
one or more weak acids;
one or more amino acids;
a surfactant; and
a liquid carrier.

14. (canceled)

15. (canceled)

16. (canceled)

17. (canceled)

18. A method of treating an area comprising one or more plants and/or plant propagation material, the method comprising applying to said area the composition according to claim 1.

19. (canceled)

20. (canceled)

21. (canceled)

22. A pre-composition comprising Aegle marmelos leaf particulate and/or an extract from Aegle marmelos leaf, the extract having been obtained with a solvent, optionally an aqueous solvent, the pre-composition being suitable for mixing with a carrier liquid to form the composition according to claim 1.

23. A package containing a pre-composition in accordance with claim 22, the package optionally being provided with instructions for forming a biostimulant composition.

24. A package containing the composition in according to claim 1, the package optionally being provided with instructions for using the composition.

25. A substrate for supporting the growth of plants and/or plant propagation material, the substrate comprising Aegle marmelos leaf particulate and/or an extract from Aegle marmelos leaf, the extract having been obtained with a solvent, optionally an aqueous solvent.

26. A method of making the composition according to claim 1, the method comprising:
producing particulate from one or more Aegle marmelos leaves, wherein the particulate comprises particles having a greatest dimension of no more than 100 nm.

27. The composition according to claim 1 comprising Aegle marmelos leaf particulate, an extract from Aegle marmelos leaf, the extract having been obtained with a solvent, and said solvent.

28. The composition according to claim 27, comprising a silicon species.
